(19) United States
(12) Patent Application Publication
(10) Pub. No.: US 2006/0020994 A1
(43) Pub. Date: Jan. 26, 2006

(54) Television signal transmission of interlinked data and navigation information for use by a chaser program

(76) Inventors: Ron Crane, Santa Cruz, CA (US); Elena Y. Pavlovskaia, Cupertino, CA (US)

Correspondence Address: Robert M. Asher;Bromberg & Sunstein LLP, 125 Summer Street, Boston, MA, 02110-1618, US

(21) Appl. No.: 10/895,776

(22) Filed: Jul. 21, 2004

(51) Int. Cl. H04N 7/173

(52) U.S. Cl. 725/113; 725/112; 725/109; 725/110

(57) ABSTRACT

Methods are provided for transmitting and navigating interlinked data using an interactive programming system. Pages of interlinked data are encoded at a network node, and data navigation information is generated for each page of the interlinked data. This data is then stored at the node. A user at a subscriber location, connected to the node by a television signal distribution network, is able to view a first page of the interlinked data, provided by the interactive programming system to the user's settop for display on a display device. The interactive programming system also provides the data navigation information to the user's settop. The interpreter within the user's settop creates a chaser, which is displayed at one of the links of the interlinked data and allows the user to navigate those links. The user may use the chaser to select a link, which is interpreted within the settop to provide a command signal identifying an action, such as sending another page of the data to the user's settop.

### TECHNICAL FIELD AND BACKGROUND ART

The present invention relates to transmitting and navigating data, in particular, transmitting and navigating interlinked data over a television signal distribution network.

Content providers are able to transmit and display interlinked content, such as Internet web pages, over a television signal distribution network. Transmitting such content to users, however, requires a large amount of computer processing power and resources. Systems have been developed in which the computing processing power and resources are located at the cable headend. Each processor chip at the headend is capable of processing and distributing content for a certain number of users. In these systems, the more users who receive the content, the more processor chips that are required for the system to function. Further, when a user attempts to navigate either on the current content or to different content, many commands must be communicated between the user's settop box and the headend. This process consumes further processor resources, which contributes to the limit of the number of users each processor chip can handle. Thus, it would be desirable to have a system that transmits interlinked content and allows for easy navigation on and among the content, while increasing the number of users serviced by each processor chip at a headend.

### SUMMARY OF THE INVENTION

In a first embodiment of the invention there is provided a method of transmitting and navigating interlinked data. The method includes encoding pages of the interlinked data in a format prior to transmission; generating corresponding data navigation information for each page of the interlinked data; sending a first page of the interlinked data and its corresponding data navigation information over a television signal distribution network to a user; and navigating to a second page of the interlinked data by receiving a signal corresponding to the user's selection of a displayed link, and interpreting the signal based on the data navigation information to create a command signal, wherein the command signal corresponds to the second page of the interlinked data and, upon being received, causes the transmission of the second page of the interlinked data and its corresponding data navigation information.

In a related embodiment, the data navigation information may further include a description of each link; and a set of metadata describing the locations and dimensions of the links, and how a signal from a user to select a link or navigate the links is interpreted. Further, encoding may include encoding, prior to transmission, pages of the interlinked data in a format capable of being displayed by a display device, such as MPEG-2 format. In addition, the method may include displaying the first page of the interlinked data on a display device. Additionally, navigating may include generating a signal from an input device by selecting a link displayed on the first page of the interlinked data.

Another embodiment of the invention is a method of providing navigable interlinked data. The method includes: encoding each page of the interlinked data in a format; generating data navigation information for each page of the interlinked data; creating a user session to communicate with a user; sending a first page of the interlinked data and the corresponding data navigation information to the user; and sending a second page of the interlinked data and the corresponding data navigation information based on a signal received from the user. Further, the data navigation information may include a description of each link; and a set of metadata describing the locations and dimensions of the links, and how a signal from a user to select a link or navigate the links is interpreted.

In a related embodiment, the method may further include scanning source data that comprises pages of interlinked data. In addition, the method may include storing the source data after it has been scanned. Further, the method may include rendering each page of the interlinked data in a first format, which may be a bitmap format. Additionally, the method may include storing the pages of interlinked data and all data navigation information in a storage unit.

In another related embodiment, the method may include communicating all pages of the interlinked data and all data navigation information from the storage unit to one of a plurality of cache managers. Further, the method may include communicating with a user through the user session. In addition, the method may include sending a first page of the interlinked data and the corresponding data navigation information to the user from the cache manager, based on signals received by the user session. Further, encoding may include encoding the interlinked data in MPEG-2 format.

Still another embodiment of the invention is a method of navigating and viewing interlinked data. The method includes: receiving a first page of interlinked data, encoded in a format before transmission; receiving data navigation information that corresponds to the first page of the interlinked data; accessing an interpreter, wherein the interpreter receives the data navigation information; viewing the first page of the interlinked data; navigating to a second page of the interlinked data by sending a signal to the interpreter, such that the interpreter interprets the signals according to the data navigation information and sends a command signal that corresponds to a second page of the interlinked data; receiving the second page of the interlinked data and its corresponding data navigation information; and viewing the second page of the interlinked data. In addition, the data navigation information may include a description of the links; and a set of metadata describing the locations and dimensions of the links, and how a signal from a user to select a link or navigate the links is interpreted.

### BRIEF DESCRIPTION OF THE DRAWINGS

The foregoing features of the invention will be more readily understood by reference to the following detailed description, taken with reference to the accompanying drawings, in which:

FIG. 1 is an overview of a cable distribution system including an interactive programming system with interlinked data.

FIG. 2 is a detailed view of the components of an interactive programming system.

FIG. 3 shows an interactive programming system with interlinked data from the perspective of a user of the system.

### DETAILED DESCRIPTION OF SPECIFIC EMBODIMENTS

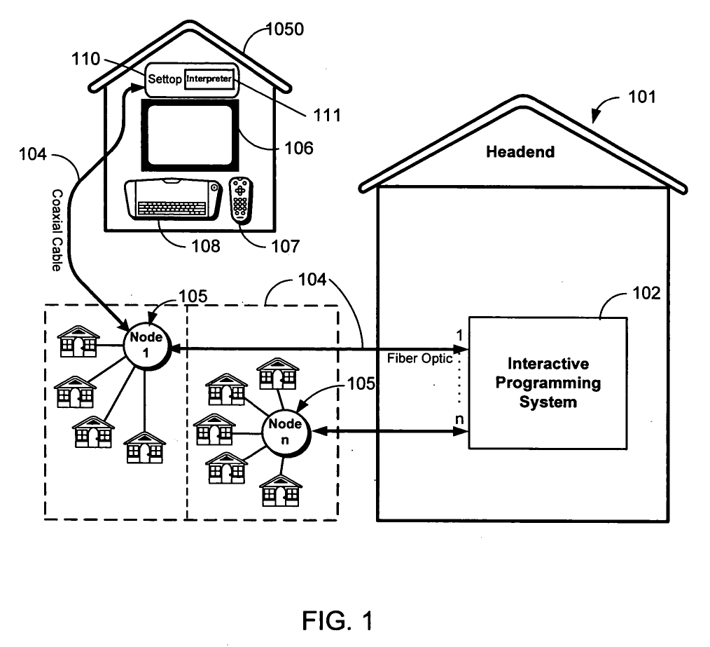

FIG. 1 is an overview of a television signal distribution network, in particular, a cable distribution network that employs an interactive programming system with interlinked data. A television signal distribution network is any system for distributing television signals to many television viewing devices, including but not limited to a cable network a, a satellite television system and a DSL television distribution network. Data is considered to be interlinked when at least two subsets of the data are connected by links, such that it is possible to move from one subset to another by using a link. A link may be any suitable way to connect at least two subsets of data, such that it is possible to move from one to the other. A link may also be used to trigger an action. An example of a link may be an HTML link between two Internet web pages. Another type of link may end a session or change the session to a different type. Another link may be used to cause the settop to tune to a different channel or signal.

Interlinked data may be any type of content that may be displayed over a cable distribution network, including but not limited to television signals, Internet pages, music, and other information such as TV guides, local weather, and sports information. The interlinked data may be content that is identical for many users of the programming system, for example all the residents of a particular town or region, and the content may be updated relatively infrequently, for example every few minutes. The interlinked data may further be composed of multiple pages, such that it is possible to move or navigate from one page of the data to another. A page of the interlinked data is a discrete set of the interlinked data that is capable of being displayed on a display device and is connected to at least one other page by a link. A page may include, for example, at least part of an Internet web page, or a menu-based screen, such as a part of television program listings.

To serve a large number of users with interlinked data, the interactive programming system encodes each page of the data in a suitable format and stores it. This allows the system to send any page of the interlinked data to any number of users who may request that page. Thus, the system does not need to encode each page of the data each time it is requested by a single user. This allows each user to browse a universe of the pages of the data while incurring only the overhead needed to find a desired page of the data and send it to the user. Thus, the resources used to encode each page of the data are amortized over the number of times users view each page.

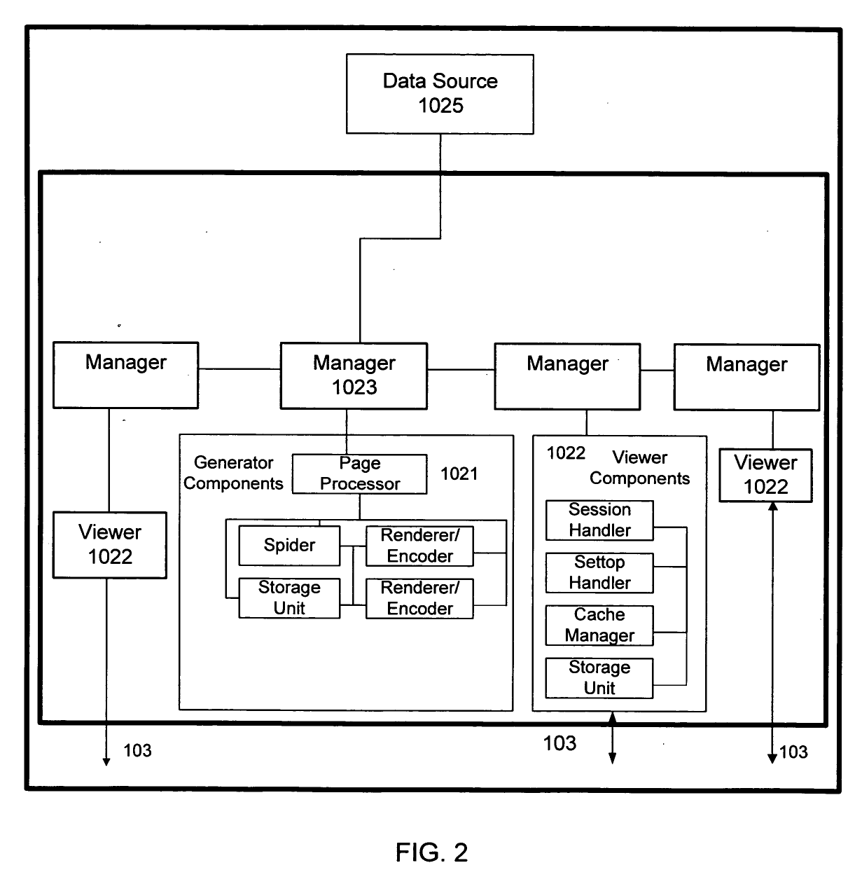

The interlinked data used by the interactive programming system 102 may be provided to the system as source data by, for example, a cable company that uses the system to provide navigable interlinked data to its users. Source data may be, for example, HTML pages that contain specific content. Source data is described in more detail below, in connection with FIG. 2.

In FIG. 1, a television signal distribution network 104 carries interlinked data from a node 101 to a plurality of subscriber locations 105. A node is a distribution point located on a television signal distribution network. A headend is an example of a node on a cable television network. At each location 105, there is at least one user 1050 who may be in an interactive session receiving at least one page of the interlinked data, at a time for viewing on a display device 106. To prepare the interlinked data for transmission, at least one interactive programming system 102 located at the node 101 begins by reading, rendering, and encoding the pages of the interlinked data. Specifically, each page of the interlinked data is encoded in a format before the data is transmitted over the television signal distribution network 104. This format may be, for example, MPEG-2 format. The interactive programming system 102 will also generate data navigation information for each page of the interlinked data. Each encoded page of the interlinked data, and its corresponding data navigation information, are then stored. A first page of the interlinked data and its corresponding data navigation information are then ready to be sent over the television signal distribution network 104, addressed to the settop 110 of the user 1050. The receiving settop 110 displays the first page of the interlinked data on a display device 106, which may be, but is not limited to, a television. The user 1050 is then able to take various actions by using, for example, keyboard 108 or input device 107. For example, the user 1050 may navigate to a second page of the interlinked data by sending a signal to an interpreter 111 in the settop 110 using, for example, the input device 107. This signal corresponds to a user selecting a link displayed on the first page of the interlinked data. The link corresponds to the second page of the interlinked data that the user 1050 desires to view. The interpreter 111 receives the signal and interprets it based on the data navigation information, so that a command signal is created. The command signal corresponds to the second page of the interlinked data and is sent from the settop 110 over the cable distribution network 104 to the interactive programming system 102. The interactive programming system 102, upon receiving the command signal, transmits the second page of the interlinked data and its corresponding data navigation information.

FIG. 2 shows the components of the interactive programming system 102, which include a plurality of grouped components: generators 1021, viewers 1022, and managers 1023. These components allow the navigable interlinked data to be provided over the television signal distribution network 104. Each manager 1023 controls either a generator 1021 or a viewer 1022. Collectively, the managers 1023 control all communications between generators 1021 and viewers 1022. The managers 1023 also allow the interactive programming system 102 to communicate with any systems that are external to the interactive programming system 102, such as but not limited to a data source 1025 or a supervisory cable system. Each manager 1023 also controls the activation and deactivation of the generator 1021 or viewer 1022 that it manages. In a preferred embodiment, communications between viewers 1022 and generators 1021 are configured so that each viewer is assigned to one generator 1021 and each generator may serve a number of viewers 1022.

The data source 1025, which may be external to the interactive programming system 102, provides the interlinked data for the system. Specifically, the data source 1025 provides collections of source data to the interactive programming system 102. The data source may be provided with already existing data, such as data existing on the Internet, but may also be provided with newly created data. A collection of source data may be any data that is divisible into distinct subsets that may be connected together in any order. The collection of source data is the interlinked data used by the interactive programming system 102. For example, a collection of source data may be, but is not limited to, a related series of HTML web pages that contains, for example, weather information for the state of Massachusetts. Thus, there is a page that may contain links to one page in the series that contains the weather information for Boston and to another page that contains the weather information for the Cape Cod region.

In addition to a subset of a collection of source data, each page of the interlinked data also contains systems information that the interactive programming system 102 uses either during the encoding or the transmitting of the interlinked data, or both. This system information may include a root variable, a default variable, an error variable, a lock variable, and an unlock variable. The root variable indicates what page of the interlinked data is the main page from which all other pages of the interlinked data are accessible. The default variable indicates which page of the data is to be displayed first when a user 1050 initiates an interactive session in communication with interactive programming system 102. The interactive session may be initiated upon turning on the settop or upon selecting an interactive channel or service using the settop remote. The interactive programming system 102 responds by creating an interactive session by any of a number of known methods. The error variable indicates what should be displayed when the interactive programming system 102 is unable to transmit the request page of the interlinked data. The lock variable and the unlock variable prevent and allow, respectively, updates that may be made to the source page graph of the interlinked data as the content of its division of source data changes.

It is convenient to organize the source data into collections such that there is one generator 1021 for each collection of source data. Each generator 1021 includes a page processor, at least one spider and at least one renderer/encoder, and a storage unit for each collection of source data. The renderer/encoder comprises two separate units, a renderer and an encoder, joined together. The spider scans the source data that makes up the pages of the interlinked data determining whether a page was added, modified or deleted since the last scan. The storage unit stores the source data after it has been scanned. The renderer unit of the renderer/encoder then renders each page of the data into a first format that is suitable for later encoding, such as but not limited to a bitmap format.

The renderer also finds all of the links on each page of the data, and generates the data navigation information for each page of the data. The data navigation information may include a description of each link for that page of the interlinked data. The description of a link identifies the action to be taken in response to the link. The description may be an identifier, uniquely identifying a target page. The target page is another page of data connected to this page by the link. A link may alternatively trigger an action. The data navigation information may also include a set of metadata. The set of metadata describes the locations and dimensions of the links on its page of the interlinked data when that page of the interlinked data is displayed. The metadata also includes information to guide user interaction with the display. As an example, when a user is on a particular link and wants to move to another link located to the right of the current link, the user presses a key, such as the right arrow key, and the interpreter 111 accesses the metadata to learn what should happen when the right arrow key is pressed. One example of a format for the data navigation information is shown below. Though this description indicates that the link is a rectangular shaped, other link shapes are possible, such as a circle or a line.

| Section | Item | Description | Size in Bits |
|---|---|---|---|
| Header (one | pageID | An ID unique | 64 |
| such section per | | among all | |
| message) | | pages that any | |
| | | Viewer can | |
| | | display. The | |
| | | Settop | |
| | | Interpreter | |
| | | ignores | |
| | | metadata | |
| | | bearing the | |
| | | pageID of the | |
| | | last metadata it | |
| | | read. | |
| Header | discardUnusedInput | Determines | 8 |
| | | whether the | |
| | | settop discards | |
| | | mouse moves | |
| | | and keys that | |
| | | are not listed in | |
| | | the message's | |
| | | “Link | |
| | | Description” | |
| | | section (see | |
| | | below). | |
| | | The “exit” and | |
| | | “F7” (exit from | |
| | | keyboard) keys | |
| | | are unaffected | |
| | | by this setting. | |
| | | 1 = discard | |
| | | keys not listed | |
| | | and mouse | |
| | | moves | |
| | | 0 = forward | |
| | | keys not listed | |
| | | and mouse | |
| | | moves normally | |
| Header | numLinks | Number of | 8 |
| | | links (number | |
| | | of chaser | |
| | | positions) on a | |
| | | page. IDs from | |
| | | 220 to 255 are | |
| | | reserved, so a | |
| | | page may have | |
| | | a maximum of | |
| | | 220 links. | |
| Header | initialLink | ID of link to be | 8 |
| | | highlighted on | |
| | | page load | |
| Header | xResolution | Screen X | 16 |
| | | resolution | |
| Header | yResolution | Screen Y | 16 |
| | | resolution | |
| Link | linkID | Link ID, also | 8 |
| Description | | known as an | |
| (one such | | identifier, | |
| section per | | unique among | |
| link) | | all links on this | |
| | | page. | |
| Link | rectTop | Y coordinate of | 16 |
| Description | | the chaser | |
| | | box's top edge. | |
| Link | rectLeft | X coordinate of | 16 |
| Description | | the chaser | |
| | | box's left edge. | |
| Link | rectBottom | Y coordinate of | 16 |
| Description | | the chaser | |
| | | box's bottom | |
| | | edge. | |
| Link | rectRight | X coordinate of | 16 |
| Description | | the chaser | |
| | | box's right | |
| | | edge. | |
| Link | chaserColor | Chaser box's | 8 |
| Description | | color. | |
| Link | chaserPattern | Chaser box's | 8 |
| Description | | pattern (such as | |
| | | crosshatching, | |
| | | etc.). | |
| Link | chaserLineWidth | Chaser box's | 8 |
| Description | | line width in | |
| | | pixels. | |
| Link | upArrowEffect | Determines the | 8 |
| Description | | effect of | |
| | | pressing this | |
| | | key while link | |
| | | is the active | |
| | | (selected) one. | |
| | | Contains either | |
| | | the ID of a link | |
| | | that should | |
| | | become active, | |
| | | or the value | |
| | | 255. The latter | |
| | | indicates that | |
| | | the settop | |
| | | should send a | |
| | | SelectAction | |
| | | message to the | |
| | | User Session, | |
| | | specifying this | |
| | | link ID. | |
| Link | downArrowEffect | As above. | As above. |
| Description | | | |
| Link | leftArrowEffect | As above. | As above. |
| Description | | | |
| Link | rightArrowEffect | As above. | As above. |
| Description | | | |
| Link | tabEffect | As above. | As above. |
| Description | | | |
| Link | shiftTabEffect | As above. | As above. |
| Description | | | |
| Link | pageDownEffect | As above. | As above. |
| Description | | | |
| Link | pageUpEffect | As above. | As above. |
| Description | | | |
| Link | homeEffect | As above. | As above. |
| Description | | | |
| Link | endEffect | As above. | As above. |
| Description | | | |
| Link | forwardKeyEffect | As above. | As above. |
| Description | | | |
| Link | backKeyEffect | As above. | As above. |
| Description | | | |

After each page of the data has been rendered, the encoder unit of the renderer/encoder encodes each page of the data in a different format, such as MPEG-2 format. When the pages of interlinked data have been encoded, and data navigation information has been generated, for each page, the interlinked data and its data navigation information are stored in the storage unit. The storage unit then notifies the page processor that the interlinked data assigned to the generator has been encoded, and data navigation information generated for each page of the data. The page processor then communicates all pages of the encoded interlinked data and its data navigation information from the storage unit to the viewers 1022 associated with the generator 1021.

Each viewer 1022 is composed of a session handler, a user session, a settop handler, and a cache manager. Each viewer is capable of producing a certain number of user sessions up to a maximum number that the viewer is capable of handling. The session handler actually creates user sessions for the viewer 1022. A session handler creates a user session when it receives a request from a settop 110 of a user 1050 seeking interlinked data from the interactive programming system 102. Communication connections between a user session and the settop 110 of its user 1050 are created, maintained, and taken down by the settop handler of the viewer 1022. The user is preferably put in communication with a viewer assigned to the generator associated with the collection of source data that the user wants to access. The settop handler also controls all communications from the user session to the user 1050 through the settop 110 and interpreter 111, and from the user 1050 through the interpreter 111 and the settop 110 to the user session. When a settop handler of a viewer 1022 receives a request for a page of interlinked data, the user session informs the cache manager of the request. The cache manager then retrieves the page from its storage unit. The generator 1021 communicates with its assigned viewer, on a periodic or as needed basis, to keep the contents of the storage unit updated.

A user session is able to access the interlinked data and its data navigation information from the cache manager by making a request for a particular page of the interlinked data to the cache manager. When the cache manager receives such a request from a user session, it records the request and responds with the desired page of the interlinked data, and its corresponding data navigation information. The desired page of the interlinked data and its corresponding data navigation information are then sent out over the cable distribution network 104, addressed to the settop 110 of the user 1050 who made the request. The user 1050 is then able to view the page of the interlinked data on display device 106. If the user 1050 wants to navigate to a different page of the interlinked data, a selection of a link to the different page is made through an input device, such as a keyboard or remote control. This generates a command signal determined by the data navigation information. The command signal is sent from the settop 110 of the user 1050 to the user session. The user session responds as described above by sending the selected page of the interlinked data, and its corresponding data navigation information, out over the television signal distribution network to the settop 110 of the user 1050. Both the page data and the data navigation information can be sent in a television signal, such as an MPEG signal. The page data is sent in video packets for display on the subscriber television. In an MPEG signal, it has been found useful to send the data navigation information in private transport packets.

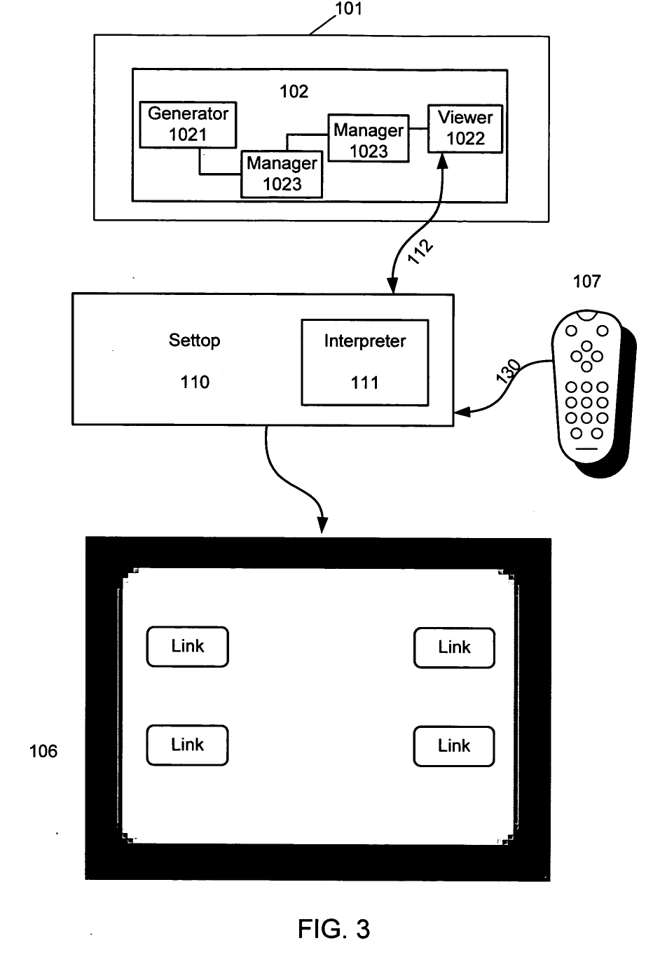

FIG. 3 shows the interactive programming system 102 as seen from the perspective of a user 1050. More specifically, for a user 1050 to view and navigate the interlinked data, the decoder of the settop 110 receives from the interactive programming system 102 a first page of the interlinked data, for display on a display device 106 through the decoder of the settop 110. The settop decodes the page and displays it. Private packets pass through to the interpreter 111. The interpreter 111 thus, receives the data navigation information to use to create a navigation and display entity, or chaser. The chaser may appear as a box surrounding a displayed link. The interpreter uses the data navigation information to render the chaser around or at the visual representation of a link on the screen of the display device 106. In particular, the interpreter uses the metadata of the data navigation information that describes the locations and dimensions of the links to accurately locate the chaser on the display. Then, when the user is viewing the decoded first page of the interlinked data on the display device 106, the user is able to also see the chaser highlighting or pointing to one of the links.

The chaser then allows the user 1050 to navigate between the links on the first page of the interlinked data by using the input device 107. The input 107 may be, for example, a remote control or a keyboard. The user 1050 sends a signal 130 to the interpreter 111 in the settop 110 by activating a selection on the input device 107. The signal 130 describes what command the user 1050 is trying to implement. For example, the user 1050 may press a down arrow key on the input device 107, signifying that the user wishes to move from a first link, which is the current active link, to another link that is below the first link. The signal 130 will then describe this command. The interpreter 111 receives the signal 130 and uses the metadata that describes how a signal from a user to navigate the links is interpreted. This metadata describes what each key of the input device 107 does, depending on what the current active link is. In this example, the metadata will indicate that pressing the down arrow key when the first link is the current active link should make the link below the first link the current active link. The interpreter will then effect this change displaying the chaser at the below link. The interpreter waits to receive its next command. The interpreter 111 is entirely responsible for handling this navigation, such that it is not necessary to send any signals back to the headend 101 to achieve the navigation. Thus, navigation from one link to another on a displayed page of the interlinked data operates entirely on the currently-displayed page of the interlinked data.

The interpreter also allows the user 1050 to navigate from a displayed first page of the interlinked data to another page of the interlinked data. To do this, the user 1050 sends a new signal 130 to the interpreter 111 in the settop 110 by pressing a button on the input device 107, such as the enter button. In this situation, the signal 130 describes that the user 1050 has selected a link on the displayed page that corresponds to a second page of the interlinked data. The word second is used to denote “next” rather than any prearranged order. Indeed, the user may select any link to pull up a desired next or second page. For example, the user 1050 may be viewing weather information for Massachusetts. The selected second page may show weather information for Boston. Desiring to view Boston's weather information, the user presses the appropriate button on the input device 107. The signal 130 is then sent to the interpreter 111. The interpreter 111 will interpret the signal 130 according to the metadata of the data navigation information. In this case, the interpreter 111 uses the metadata that describes how a signal from a user to select a particular link is interpreted. The metadata here will indicate that when a user 1050 selects the chosen link, the user wants a second page of the interlinked data. The metadata contains an identifier that corresponds to the second page of the interlinked data. This identifier is sent from the interpreter 111 in the settop 110 as a command signal 112 back to the interactive programming system 102. The command signal 112 is transmitted over the upstream communications channel of the cable distribution network 104. Alternative upstream channels may also be used, such as telephone lines or wireless connections. The viewer 1022, more particularly the user session, receives the command signal 112. It uses the identifier in the command signal 112 to request the second page of the interlinked data, and its data navigation information, from the cache manager. After the user session receives the second page of the data navigation information and its data navigation information, these are sent over the television signal distribution network 104 to the settop 110. The settop 110 receives the second page and its data navigation information. The settop 110 then causes the second page of the interlinked data to be displayed on the display device 106. The interpreter 111 receives the data navigation information for the second page of the interlinked data, displays the appropriate links for the second page, and creates a new chaser according to the new data navigation information. The user 1050 is then able to view the second page, and may navigate its links or select one of its links to access still another page of the interlinked data or take some other action. Thus, to navigate to a different page of the interlinked data, the user 1050 need only send the identifier in the command signal 112 back to the interactive programming system 102 at the headend 101. The interpreter 111 has performed the necessary interpretation of the signal 130 received from the input device 107; the signal 130 itself need not be sent to the headend 101.

The chaser display must be synchronized with the page display so that the chaser based on a previous page does not appear on a new page. Thus, when a user requests any action with signal 130 that may require replacing currently displayed page, the interpreter 111 locks and erases the chaser. While it is locked, the chaser is prevented from further navigation on the page. The interpreter discards any user input following the requested action. The interpreter sends the selected link's identifier via a command signal 112 to the interactive programming system 102. Chaser navigation and user input remain locked until the interpreter has received a new set of navigation information. Thus, the user can not move the chaser until the settop is displaying the next page (if any). The locking and erasing of the chaser avoids display of a chaser in a position that does not correspond to the displayed image. Upon receiving the page and its navigation information, the chaser can be displayed and navigation can resume. If the action requested by the user was for a session switch or change of service and the request is denied, the interactive programming system can resend the current page and its navigation information so that the chaser can be re-displayed.

The present invention may be embodied in other specific forms without departing from the true scope of the invention. The described embodiments are to be considered in all respects as illustrative only and not restrictive.

What is claimed is:

1. A method of transmitting and navigating interlinked data, comprising:
encoding pages of the interlinked data in a format prior to transmission;
generating corresponding data navigation information for each page of the interlinked data;
sending a first page of the interlinked data and its corresponding data navigation information over a television signal distribution network to a user;
navigating to a second page of the interlinked data by receiving a signal corresponding to the user's selection of a displayed link, and interpreting the signal based on the data navigation information to create a command signal, wherein the command signal corresponds to the second page of the interlinked data and, upon being received, causes the transmission of the second page of the interlinked data and its corresponding data navigation information.

2. A method according to claim 1, wherein the data navigation information further comprises
a description of each link; and
a set of metadata describing locations and dimensions corresponding to each link, and how a signal from a user to select a link or navigate the links is interpreted.

3. A method according to claim 1, wherein encoding further comprises encoding pages of the interlinked data in MPEG-2 format prior to transmission.

4. A method according to claim 1, further comprising displaying the first page of the interlinked data on a display device.

5. A method according to claim 1, wherein navigating further comprises generating a signal from an input device by selecting a link displayed of the first page of the interlinked data with the input device.

6. A method according to claim 1, wherein the television signal distribution network comprises a cable network.

7. A method of providing navigable interlinked data, comprising:
encoding each page of the interlinked data in a format;
generating data navigation information for each page of the interlinked data;
creating a user session at a node of a television signal distribution network to communicate with a user;
sending a first page of the interlinked data and the corresponding data navigation information over a television signal distribution network to the user; and
sending, over the television signal distribution network, a second page of the interlinked data and the corresponding data navigation information based on a signal received from the user.

8. A method according to claim 7, wherein the data navigation information further comprises
a description of each link of the interlinked data; and
a set of metadata describing locations and dimensions corresponding to each link, and how a signal from a user to select a link or navigate the links is interpreted.

9. A method according to claim 8, further comprising reading source data that comprises pages of interlinked data.

10. A method according to claim 9, further comprising storing the results of reading the source data after the source data has been read.

11. A method according to claim 10, further comprising rendering each page of the interlinked data in a first format.

12. A method according to claim 11, wherein rendering further comprises rendering each page of the interlinked data in a bitmap format.

13. A method according to claim 12, further comprising storing pages of the interlinked data and corresponding data navigation information in a storage unit.

14. A method according to claim 13, further comprising communicating pages of the interlinked data and corresponding data navigation information from the storage unit to a cache manager.

15. A method according to claim 14, wherein the cache manager provides the first page of the interlinked data and the corresponding data navigation information for sending to the user.

16. A method according to claim 15, wherein encoding further comprises encoding the interlinked data in MPEG-2 format.

17. A method according to claim 7 wherein the television signal distribution network comprises a cable network.

18. A method of navigating and viewing interlinked data, the method comprising:
receiving a first page of interlinked data, encoded in a format before transmission, over a television signal distribution network;
receiving, over the television signal distribution network, data navigation information that corresponds to the first page of the interlinked data;
accessing an interpreter, wherein the interpreter receives the data navigation information;
viewing the first page of the interlinked data;
navigating to a second page of the interlinked data by sending a signal to the interpreter, such that the interpreter interprets the signals according to the data navigation information and sends a command signal that corresponds to a second page of the interlinked data;
receiving the second page of the interlinked data and its corresponding data navigation information; and
viewing the second page of the interlinked data.

19. A method according to claim 18, wherein the data navigation information further comprises
a description of each link of the interlinked data; and
a set of metadata describing locations and dimensions corresponding to each link, and how a signal from a user to select a link or navigate the links is interpreted.

20. A method according to claim 18, wherein receiving further comprises receiving a first page of interlinked data, encoded in MPEG-2 format before transmission.

21. A method according to claim 18, wherein navigating further comprises selecting a link of the first page of the interlinked data with an input device, and sending the selection in a signal to the interpreter.

22. A method according to claim 18 wherein the television signal distribution network comprises a cable network.
